(19) United States
(12) Patent Application Publication
(10) Pub. No.: US 2022/0180406 A1
(43) Pub. Date: Jun. 9, 2022

(54) SYSTEM AND METHOD FOR PROCESSING DONATION MATCHING

(71) Applicant: Early Warning Services, LLC, Scottsdale, AZ (US)

(72) Inventors: David Palty, Chandler, AZ (US); Jaylean Kedwards, Phoenix, AZ (US); Ashley Montanaro, Phoenix, AZ (US); Bryan Bonilla, Goodyear, AZ (US); Donna Russell, Phoenix, AZ (US); Laura Weinflash, Scottsdale, AZ (US)

(73) Assignee: Early Warning Services, LLC, Scottsdale, AZ (US)

(21) Appl. No.: 17/112,638

(22) Filed: Dec. 4, 2020

(51) Int. Cl. G06Q 30/02; G06Q 20/42; G06Q 40/02; G06Q 20/10; G06Q 20/40; G06Q 30/00; G06Q 20/02; G06Q 50/26; G06Q 10/10; H04L 29/06; G06F 16/23

(52) U.S. Cl. CPC G06Q 30/0279; G06Q 20/42; G06Q 40/02; G06Q 20/108; G06Q 20/405; G06F 16/2379; G06Q 20/02; G06Q 50/265; G06Q 10/1057; H04L 63/0853; G06Q 30/0185

(57) ABSTRACT

A method including a system receiving, through a computer network, a donation authorization from a donor via a donor user interface executed on a donor device. The method further can include, after receiving the donation authorization, determining by the system, in real-time, whether the donation authorization complies with a matching policy of the matching donor. The method further can include, after determining that the donation authorization complies with the matching policy, determining by the system, in real-time, a matching donation amount based at least in part on the matching policy. The matching donation amount can be less than, equal to, or greater than the donation amount. The method further can include, after determining the matching donation amount, facilitating by the system, through the computer network: (i) a first electronic fund transfer of the donation amount from the sender account maintained by the sender financial institution to the receiver account maintained by the receiver financial institution; and (ii) a second electronic fund transfer of the matching donation amount from the matching sender account maintained by the matching sender financial institution to the receiver account maintained by the receiver financial institution. Other embodiments are disclosed.

### TECHNICAL FIELD

The technical field relates to systems and methods for processing online donations, and more particularly to systems and methods for processing donation matchings, initiated by donors through their online donations.

### BACKGROUND

Donation matching benefits charities by increasing their revenues, and also benefits corporations by fulfilling corporate social responsibilities and boosting employee morale. However, the risk of charity fraud can deter corporations from allowing automatic donation matching, especially for donations to less famous charities. Further, most corporations have their respective requirements and/or limitations about donation matching, and requiring charities and/or employees to apply for donation matching, and for employers to review, each donation made by an employee can be burdensome for the charities, employees, and large corporations, in particular. These factors thus can negatively influence the willingness of corporations to participate in donation matching programs. Accordingly, systems and methods are desired to allow employees to initiate donation matching, automatically vet the charity status of the donees, and automatically verify the compliance of the donation matching with business policies of the employers.

### BRIEF DESCRIPTION OF THE DRAWINGS

To facilitate further description of the embodiments, the following drawings are provided in which:

FIG. 1 depicts a schematic diagram of a system that can be adopted for processing donations and corresponding donation matchings, according to an embodiment;

FIG. 2 illustrates a flow chart for a method, according to an embodiment;

FIG. 3 illustrates a flow chart for a method, according to an embodiment;

FIG. 4 illustrates a flow chart for a method, according to an embodiment;

FIG. 5 illustrates a flow chart for a method, according to an embodiment;

FIG. 6 illustrates a computer that is suitable for implementing an embodiment of components of the system of FIG. 1; and

FIG. 7 illustrates a representative block diagram of an example of elements included in circuit boards inside a chassis of the computer of FIG. 6.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, five seconds, ten seconds, thirty seconds, one minute, or five minutes.

### DESCRIPTION OF EXAMPLES OF EMBODIMENTS

Various embodiments include a system comprising one or more processing modules and one or more non-transitory memory storage modules storing computing instructions configured to run on the one or more processing modules and perform certain acts. The acts can include receiving, through a computer network, a donation authorization directly or indirectly from a donor via a donor user interface executed on a donor device. The donation authorization can comprise a donation amount and/or a donor token for the donor. The donor token can be uniquely associated with a sender account associated with the donor and maintained by a sender financial institution. The donation amount can correspond to a donee token for a donee, wherein the donee token is uniquely associated with a receiver account for the donee and maintained by a receiver financial institution. The donation amount further can correspond to a matching donor token for a matching donor, wherein the matching donor token is uniquely associated with a matching sender account for the matching donor and maintained by a matching sender financial institution. The sender financial institution, the receiver financial institution, and/or the matching sender financial institution can be the same or different from each other.

The donee token for the donee, the matching donor token for the matching donor, and/or other information can be included in the donation authorization from the donor or can be received by the system from the donor, separately or together, before the system receives the donation authorization. Each of the donor token, the matching donor token, and the donee token can be a public token (e.g., an email address, a machine-readable code, or a phone number), or a private token (e.g., a social security number, a driver license number, or an account number). The association between the donor token and the sender account can be maintained by the system and/or a system for the sender financial institution. The association between the donee token and the receiver account can be maintained and/or accessible by the system and/or a system for the receiver financial institution. The association between the matching donor token and the matching sender account can be maintained by the system and/or a system for the matching sender financial institution. Such implementation is advantageous because the donors, the matching donors, and/or donees can engage in donation transactions and/or donation matchings without disclosing their respective confidential or private financial information such as bank account information.

The matching donor can be any entity that participates in donation matching for one or more donations made by the donor. Examples of a matching donor for a donor can include an employer of the donor, a parent of the donor, an entity that participates for reasons unrelated to the donor, such as a benefactor that agrees to match any donations to a specific charity in the current month up to 2 million dollars, and so forth. In an embodiment where a donor can be a receiver of repeated payments from a matching donor (e.g., an employee of the matching donor, a beneficiary of a trust, etc.), and where the donation amount can be deducted from the donor's next scheduled payment (e.g., the next paycheck), the sender account associated with the donation transaction can be: (a) a donor account uniquely associated with the donor, or (b) a payment account (e.g., a payroll account) uniquely associated with the matching donor, based on the donor's choice in the donation authorization or the donor's settings in the donor's profile. In similar or alternate embodiments, the matching sender account can be the sender account, and the matching sender financial institution can be the sender financial institution. In certain embodiments, the matching sender financial institution can be the sender financial institution while the matching sender account is different from the sender account.

In a number of embodiments, the acts to be performed by the computer instructions of the system also can include, after receiving the donation authorization through the computer network, determining, in real-time, whether the donation authorization complies with a matching policy of the matching donor. The matching policy can be predetermined by and received, through the computer network, from the matching donor via a matching donor user interface executed on a matching donor device. The matching policy can include various requirements and/or limitations related to eligible donors, amounts and/or timing for donation matching, charities as eligible donees, etc.

The acts further can include, after determining that the donation authorization complies with the matching policy, determining, in real-time, a matching donation amount based at least in part on the matching policy. The matching donation amount can be less than, equal to, or greater than the donation amount. In some embodiments, the matching donation amount can be a fixed amount. In certain embodiments, the matching donation amount can be determined based on the donation amount to be made by the donor, such as a certain percentage of the donation amount (10%, 50%, 100%, 200%, etc.) and/or with additional conditions (e.g., matching a percentage when the donation amount is greater than a minimum amount, such as $20, and/or until the matching donation reaches a maximum amount, such as $10,000; or matching a first percentage for full-time employees and a second percentage for part-time employees, etc.).

The acts additionally can include, after determining the matching donation amount, facilitating, through the computer network: (a) a first electronic fund transfer of the donation amount from the sender account maintained by the sender financial institution to the receiver account maintained by the receiver financial institution; and (b) a second electronic fund transfer of the matching donation amount from the matching sender account maintained by the matching sender financial institution to the receiver account maintained by the receiver financial institution. In certain embodiments, facilitating an electronic fund transfer can include forwarding, via the computer network, instructions to the respective financial institutions to transfer the fund between them. In some embodiments, facilitating an electronic fund transfer can include providing, via the computer network, a respective risk score concerning the fund transfer to each of the financial institutions. For instance, facilitating the electronic fund transfer, either from the sender account maintained by the sender financial institution or from the matching sender account maintained by the matching sender financial institution to the receiver account maintained by the receiver financial institution, can include providing a first risk score to the sender or matching sender financial institution and providing a second risk score to the receiver financial institution, so that the respective financial institutions can determine whether they will perform the electronic fund transfer. In a few embodiments, the first and second risk scores can be determined based on a likelihood of fraud and/or any financial crimes by the donor, the matching donor, and/or the donee. Factors for the system to determine the risk scores can include the history of the respective account and/or the respective credit report for the donor, the matching donor, and/or the donee. The first risk score and the second risk score can be the same or different from each other.

In some embodiments, the act of determining whether the donation authorization complies with the matching policy can comprise determining, in real-time, whether one or more of aspects for the donation authorization meet one or more donation matching criteria predetermined by the matching donor, via the matching donor user interface executed on the matching donor device. The one or more donation matching criteria of an exemplary matching policy can include: (a) eligibility of a donor, such as whether the donor is a full-time employee; (b) acceptable types of donees, such as U.S. based nonprofits, environmental organizations, and/or educational institutions, etc., or unacceptable types of donees; (c) a maximum accumulated amount the matching donor is willing to spend on all the matching donations per month, year, or another period of time; (d) a maximum amount that the matching donor agrees to spend on a certain donee or a certain type of donees, and/or a maximum accumulated amount or a maximum count of donations made by the donor that the matching donor is willing to match per month, year, or another period of time; and/or (e) a formula to calculate the matching amount, such as a fixed amount or a certain percentage for each matching donation; and/or other one or more criteria, such as criteria for determining whether and/or when a matching approval for a matching donation amount from the matching donor is required, etc.

In some embodiments, the act of determining whether the donation authorization complies with the matching policy also can comprise vetting, in real-time, a donee status and/or other information of the donee. The donee information to be vetted can include a tax-exempt status, a good-standing status, the account number of the receiver bank account, the name, the tax identification such as the social security number or the Employer Identification Number (EIN), the existence of any criminal records, and/or other information associated with the donee. In some embodiments, vetting the donee information of the donee can be implemented by retrieving, in real-time and through the computer network, from the receiver financial institution a good-standing status associated with the receiver bank account. In similar or different embodiments, vetting the donee information of the donee additionally or alternatively can be done by retrieving, in real-time and through the computer network, from a charity vetting server a charity status associated with the donee. In a few embodiments, vetting the donee information of the donee can include verifying the donee information based on information obtained from credible public sources, such as the databases of government agencies or tax authorities for tax-exempt organizations. Such implementation is advantageous because it can prevent fraud and financial crimes in real-time and also because it can give donors and matching donors confidence that their contributions make a real impact to society.

In similar or different embodiments, vetting the donee status and/or other information of the donee additionally or alternatively can be performed at one or more occasions, including, (a) when the system receives, through the computer network, a donee registration request from the donee via a donee user interface executed on a donee device of the donee; (b) before the system transmits, through the computer network, a search result associated with one or more registered donees to be displayed on the donor user interface, in response to a search inquiry by the donor via the donor user interface, the one or more registered donees comprising the donee; (c) before the system facilitates the first electronic fund transfer; (d) before the system facilitates the second electronic fund transfer; (e) when a predetermined time has passed after a prior vetting was performed; and/or (f) when the system randomly chooses a transaction or a registered donee to perform the vetting, and so forth.

In some embodiments, the acts further can include, before receiving the donation authorization from the donor, receiving, through the computer network, the donee token from the donor via the donor user interface. Receiving the donee token can include allowing the donor to: (a) select, via the donor user interface, the donee from a list of registered donees, such as all of the registered donees, a search result based on a search inquiry provided by the donee, or a “favorite donees” list for the donor; and/or (b) provide a donee token of the donee, via the donor user interface. The acts also can include, after the donee token is received, making, in real-time, a determination of whether the donee is registered. In certain embodiments, the acts further can include, when the determination indicates that the donee is not registered, sending, in real-time through the computer network, a donee registration invitation, directly or indirectly, to the unregistered donee. The donee registration invitation can include an email, a text message, and/or a push notification, etc. that comprises a registration form and/or a link to an online donee registration form and is transmitted through the computer network to either the donee or the donor. When the donee registration invitation is sent to the donor, the donee registration invitation further can include instructions for the donor to forward the invitation to the donee. In similar or different embodiments, the acts also or alternatively can include, when it is determined that the donee is not registered, sending, in real-time through the computer network, an error message to be displayed on the donor user interface.

In a number of embodiments, the acts also can include, before receiving the donation authorization by the donor, receiving, through the computer network, the matching donor token from the donor via the donor user interface. Receiving the matching donor token can comprise automatically determining the registered matching donor based on a profile of the donor (e.g., searching for the employer of the donor from a database for registered matching donors), or allowing the donor to: (a) select the registered matching donor from a list of registered matching donors, wherein the list can be a full list of all of the registered matching donors or a search result associated with one or more registered matching donors determined based on a search inquiry by the donor; or (b) provide the matching donor token of the matching donor, via the donor user interface. The acts further can include, when the donor enters or submits the matching donor token, rather than selecting from the list, determining in real-time whether the matching donor token provided by the donor is associated with a registered matching donor. In some embodiments, the acts also can include, when it is determined that the matching donor is not registered, sending, in real-time through the computer network, a matching donor registration invitation, directly or indirectly, to the unregistered matching donor. The matching donor registration invitation can include an email, a text message, and/or a push notification, etc. that comprises a registration form and/or a link to an online matching donor registration form and is transmitted through the computer network to either the unregistered matching donor or the donor so that the donor can forward the invitation to the unregistered matching donor.

In some embodiments, the act of facilitating the first electronic fund transfer of the donation amount further can comprise: facilitating, through the computer network, the sender financial institution to withhold the donation amount from the sender account; and facilitating, through the computer network, the receiver financial institution to post the donation amount to the receiver account. In certain embodiments, the act of facilitating the second electronic fund transfer of the matching donation amount further can comprise: facilitating, through the computer network, the matching sender financial institution to withhold the matching donation amount from the matching sender account; and facilitating, through the computer network, the receiver financial institution to post the matching donation amount to the receiver account.

Some or all of the aforementioned acts, (a) facilitating the sender financial institution to withhold the donation amount; (b) facilitating the receiver financial institution to post the donation amount; (c) facilitating the matching sender financial institution to withhold the matching donation amount; and/or (d) facilitating the receiver financial institution to post the matching donation amount, can be performed in real-time, simultaneously, independently, and/or in any suitable sequence. For instance, the computer instructions of an exemplary system can perform these acts in the following sequence: (1) facilitating the sender financial institution to withhold the donation amount, (2) facilitating the receiver financial institution to post the donation amount, (3) facilitating the matching sender financial institution to withhold the matching donation amount, and (4) facilitating the receiver financial institution to post the matching donation amount. The computer instructions of another exemplary system can perform these acts in another sequence: (1) facilitating the sender financial institution to withhold the donation amount, while simultaneously facilitating the matching sender financial institution to withhold the matching donation amount, and (2) facilitating the receiver financial institution to post the donation amount, while simultaneously facilitating the receiver financial institution to post the matching donation amount.

Further, the acts can include, before facilitating the first electronic fund transfer and the second electronic fund transfer, receiving, through the computer network, a matching approval for the matching donation amount from the matching donor via the matching donor user interface. The acts also can include, before receiving the matching approval, sending, through the computer network, a request for approving the matching donation amount to be displayed on the matching donor user interface. The acts additionally can include determining whether the matching approval is required based on the matching policy of the matching donor. For instance, the matching policy of a matching donor can provide that a matching approval is always needed or required only under certain circumstances, such as when a matching donation amount exceeds a certain amount, such as $500, or when the donee is not in a list of preapproved donees for the matching donor, etc.

In embodiments where the sender account can be the matching sender account, facilitating the first electronic fund transfer and the second electronic fund transfer can comprise facilitating, through the computer network, a single electronic fund transaction of a total or combined amount of the donation amount and the matching donation amount from the sender account maintained by the sender financial institution to the receiver account maintained by the receiver financial institution.

In some embodiments, the acts further can include, before receiving the donation authorization, providing a user interface (e.g., a form, a questionnaire, or interactive webpages) for configuring a matching policy, to be executed on the matching donor device, and storing the matching policy at a database communicably coupled to the system. In similar or different embodiments, the matching policy can be stored remotely and retrieved by the system, in real-time via the computer network, from a server. In several embodiments, the user interface for configuring the matching policy can be included in, or activated by, a user interface for receiving an application to register from an unregistered matching donor. In a number of embodiments, a registered matching donor can change the associated matching policy via the user interface for configuring the matching policy.

In a number of embodiments, the donation authorization can be associated with a one-time donation or repeated donations. In several embodiments, the acts also can include allowing a donor to set up a series of repeated donations, via the donor user interface through the computer network. Once the series of repeated donations is set up, the act of receiving the donation authorization can include automatically generating the donation authorization at a predetermined time based on the series of repeated donations until a predetermined expiration date. In other or similar embodiments where the donor can set up the series of repeated donations in advance, the acts further can include having a separate system automatically generate the donation authorization at the predetermined time based on the series of repeated donations until the predetermined expiration date. Examples of the separate system can include the donor device, a system of the sender financial institution, or any other suitable device/system.

Various embodiments include a method being implemented via one or more processing modules and one or more non-transitory memory storage modules storing computing instructions configured to run on the one or more processing modules. The method can include one or more steps, and the one or more steps each can be similar or identical to any of the one or more acts for the exemplary systems provided above. The one or more steps of the method can be performed in an order similar to or different from the order in which the one or more acts are provided or described above. An exemplary method can include: (a) receiving, through a computer network, a donation authorization from a donor via a donor user interface executed on a donor device; (b) after receiving the donation authorization, determining, in real-time, whether the donation authorization complies with a matching policy of a matching donor; (c) after determining that the donation authorization complies with the matching policy, determining, in real-time, a matching donation amount based at least in part on the matching policy; and (d) after determining the matching donation amount, facilitating, through the computer network: (i) a first electronic fund transfer of the donation amount from a sender account, that is associated with the donor and maintained by the sender financial institution, to a receiver account, that is associated with a donee associated with a donation amount of the donation authorization and that is maintained by a receiver financial institution; and (ii) a second electronic fund transfer of the matching donation amount from a matching sender account, that is associated with the matching donor and maintained by a matching sender financial institution, to the receiver account maintained by the receiver financial institution.

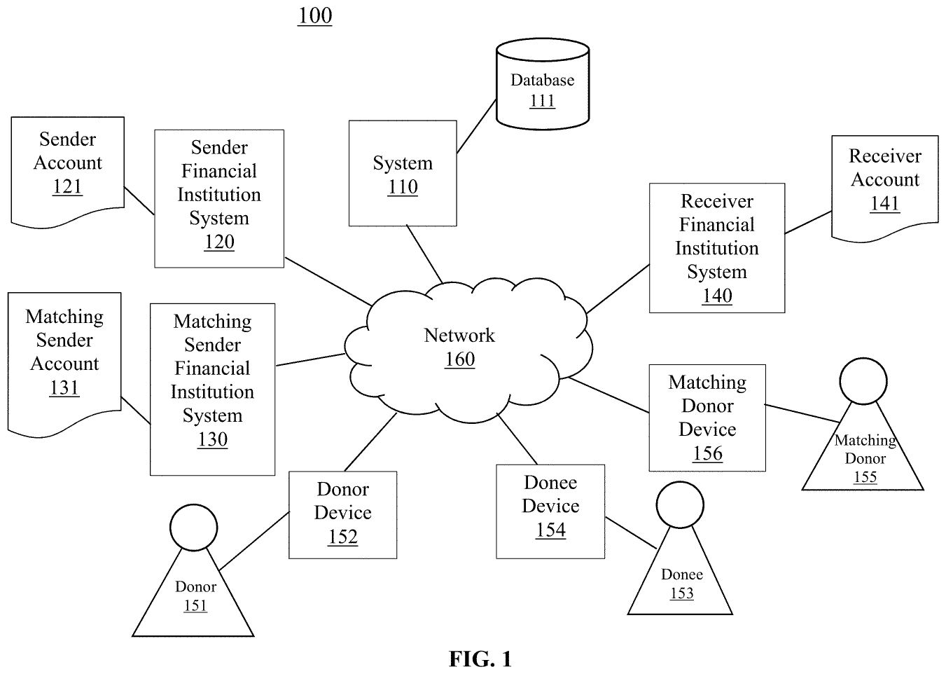

Turning to the drawings, FIG. 1 illustrates a block diagram of a system 100 that can be employed for processing online donations and associated donation matching, according to an embodiment. System 100 is merely exemplary and embodiments of the system are not limited to the embodiments presented herein. The system can be employed in many different embodiments or examples not specifically depicted or described herein. In some embodiments, certain elements, systems, subsystems, or modules of system 100 can perform various procedures, processes, and/or activities. In other embodiments, the procedures, processes, and/or activities can be performed by other suitable elements, systems, subsystems, or modules of system 100.

Referring to FIG. 1, system 100 can include one or more systems, such as a system 110, one or more financial institutions, such as a sender financial institution system 120, a matching sender financial institution system 130, and/or a receiver financial institution system 140, a plurality of financial accounts, such as a sender account 121, a matching sender account 131, and/or a receiver account 141, one or more user computing devices, such as a donor device 152 of a donor 151, a donee device 154 of a donee 153, and/or a matching donor device 156 of a matching donor 155. In a number of embodiments, system 110 can include one or more elements, modules, subsystems, and/or systems. In certain embodiments, sender financial institution system 120 can comprise matching sender financial institution 130 and/or receiver financial institution system 140, or vice versa. In a few embodiments, donor device 152 can comprise donee device 153 and/or matching donor device 156, or vice versa.

In a number of embodiments, system 110 can comprise one or more processors and one or more non-transitory computer-readable media storing computing instructions configured to run on the one or more processors and perform some acts. In some embodiments, the acts can include: (a) receiving by system 110, through a computer network (e.g., a network 160), a donation authorization from donor 151, via a donor user interface executed on donor device 152; (b) after receiving the donation authorization, determining by system 110, in real-time, whether the donation authorization complies with a matching policy of matching donor 155; (c) after determining that the donation authorization complies with the matching policy, determining by system 110, in real-time, a matching donation amount based at least in part on the matching policy; and (d) after determining the matching donation amount, facilitating by system 110, through network 160: (i) a first electronic fund transfer of the donation amount from sender account 121 maintained by sender financial institution system 120 to receiver account 141 maintained by receiver financial institution system 140; and (ii) a second electronic fund transfer of the matching donation amount from matching sender account 131 maintained by matching sender financial institution system 130 to receiver account 141 maintained by receiver financial institution system 140. In embodiments where the acts include facilitating the first electronic fund transfer and/or the second electronic fund transfer, the facilitating can include providing a risk score to one or more of the financial institutions, including sender financial institution system 120, matching sender financial institution system 130, and/or receiver financial institution system 140, to allow the one or more of the financial institutions to decide whether to transfer/receive the donation amount and/or the matching donation amount.

In a number of embodiments, the donation authorization can comprise a donation amount and/or a donor token for the donor, such as donor 151. The donor token can be uniquely associated with a sender account for the donor, such as sender account 121 for donor 151, and maintained by a sender financial institution, such as sender financial institution system 120. The donation amount can correspond to a donee token for a donee, such as donee 153, and/or a matching donor token for a matching donor, such as matching donor 155. The donee token can be uniquely associated with a receiver account for the donee, such as receiver account 141 for donee 153, and the receiver account can be maintained by a receiver financial institution, such as receiver financial institution system 140. The matching donor token can be uniquely associated with a matching sender account for the matching donor, such as matching sender account 131 for matching donor 155, and the matching sender account can be maintained by a matching sender financial institution, such as matching sender financial institution 130. In some embodiments, the donation authorization can include the donee token for donee 153 and/or the matching donor token for matching donor 155. In certain embodiments, the matching policy can be predetermined by and received through the computer network, such as network 160, from the matching donor, such as matching donor 155, via a matching donor user interface executed on the matching donor device, such as matching donor device 156.

In several embodiments, a single one of the modules, subsystems, or systems in system 110, can be configured to perform all the aforementioned act(s) performed by system 110. In a number of embodiments, a plurality of modules, subsystems, and/or systems in system 110 can be configured to work with each other to perform one or more acts for processing donation matching.

Still referring to FIG. 1, in many embodiments, system 110 can comprise one or more of a financial institution, an inter-financial-institution payment network, or a third-party real-time payment processor, etc. The donor token, the matching donor token, and/or the donee token each can be an email address, a phone number, a machine readable code, or any suitable identifier corresponding to a respective account, such as sender account 121, matching sender account 131, and/or receiver account 141. In some embodiments, the association(s) between the donor token and sender account 121, between the matching donor token and matching sender account 131, and/or between the donee token and receiver account 141 each can be stored in a database, such as database 111, that is communicably connected to system 110, directly or indirectly through network 160.

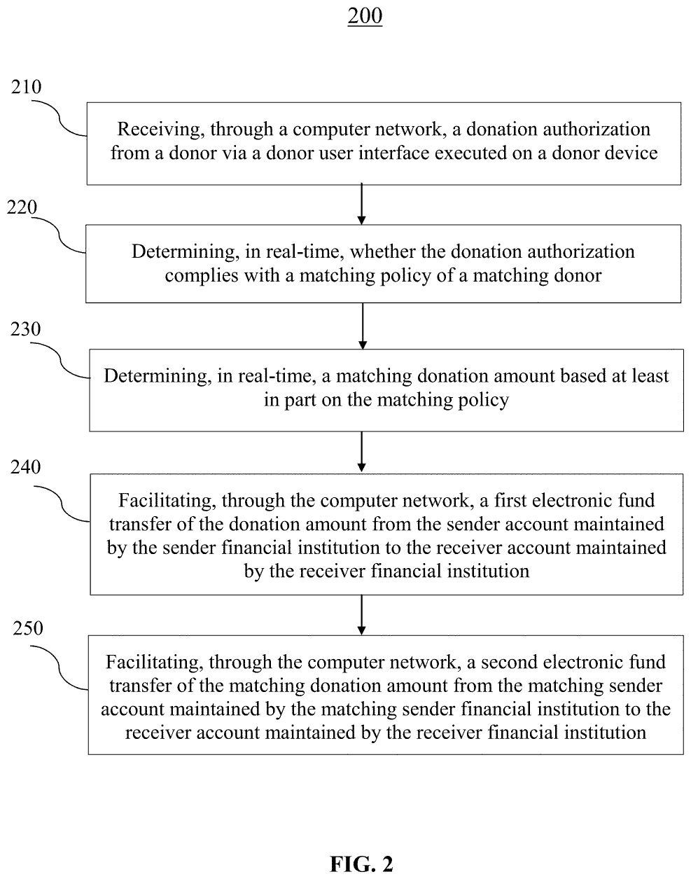

Turning ahead in the drawings, FIG. 2 illustrates a flow chart for a method 200, according to an embodiment. In some embodiments, method 200 can be a method of processing donation matching. Method 200 is merely exemplary and is not limited to the embodiments presented herein. Method 200 can be employed in many different embodiments or examples not specifically depicted or described herein. In some embodiments, the procedures, the processes, and/or the activities of method 200 can be performed in the order presented. In other embodiments, the procedures, the processes, and/or the activities of method 200 can be performed in any suitable order. In still other embodiments, one or more of the procedures, the processes, and/or the activities of method 200 can be combined or skipped. In some embodiments, method 200 can be performed by system 100 and/or system 110 (FIG. 1).

Referring to FIG. 2, in some embodiments, method 200 can include one or more blocks. Specifically, method 200 can include block 210 of a system receiving, through a computer network, a donation authorization from a donor, via a donor user interface executed on a donor device. The system can be similar or identical to system 100 and/or system 110 (FIG. 1). The computer network can be similar or identical to network 160 (FIG. 1). The donor can be similar or identical to donor 151 (FIG. 1). The donor device can be similar or identical to donor device 152 (FIG. 1).

In a number of embodiments, the donation authorization can comprise a donation amount and/or a donor token for the donor, such as donor 151 (FIG. 1). The donor token can be uniquely associated with a sender account, such as sender account 121 (FIG. 1), for the donor and maintained by a sender financial institution, such as sender financial institution system 120 (FIG. 1). The donation amount can correspond to a donee token for a donee, such as donee 153 (FIG. 1), and/or a matching donor token for a matching donor, such as matching donor 155 (FIG. 1). In certain embodiments, the donation authorization also can include the donee token and/or the matching donor token. In different or similar embodiments, the donee token and/or the matching donor token can be received by the system, through the computer network, before the system receives the donation authorization. The donee token can be uniquely associated with a receiver account for the donee, such as receiver account 142 (FIG. 1), and the receiver account can be maintained by a receiver financial institution, such as receiver financial institution system 140 (FIG. 1). The matching donor token can be uniquely associated with a matching sender account for the matching donor, such as matching sender account 131 for matching donor 155, and a matching sender financial institution, such as matching sender financial institution 130, can be configured to maintain the matching sender account.

Still referring to FIG. 2, in some embodiments, method 200 further can include block 220 of the system, such as system 100 or 110 (FIG. 1), determining, in real-time, whether the donation authorization complies with a matching policy of the matching donor, such as matching donor 155 (FIG. 1). The matching policy can include one or more rules related to one or more of: (a) whose donation is eligible to trigger donation matching; (b) what kind of donee is eligible to receive donation matching; and/or (c) one or more budget limitations, etc. For example, the matching policy can include a first prospective accumulated amount by the matching donor, such as a total budget for donation matching per fiscal year. The matching policy further or alternatively can include a second prospective accumulated amount, associated with one or more of the donor or the donee, by the matching donor, such as a maximum amount for matching the donation(s) made by an employee or for contributing to a specific donee or to donees in a certain category or geographic area, etc. The matching policy also can include whether and/or when approval by the matching donor is required.

In a number of embodiments, method 200 additionally can include block 230 of the system, such as system 100 or 110 (FIG. 1), determining, in real-time, a matching donation amount based at least in part on the matching policy. The matching donation amount can be less than, equal to, or greater than the donation amount. In some embodiments, the matching donation amount can be a fixed amount per donation made by an eligible donor to an eligible donee. In certain embodiments, the matching donation amount also can be determined based at least in part on the donation amount of the donation authorization by the donor. For instance, the matching donation amount can be determined based on a percentage, such as 2% or 5%, of the donation amount, up to a certain amount per donation matching, such as $100.

In some embodiments, method 200 further can include block 240 of the system, such as system 100 or 110 (FIG. 1), facilitating, through the computer network, such as network 160 (FIG. 1), a first electronic fund transfer of the donation amount from the sender account, such as sender account 121 (FIG. 1), maintained by the sender financial institution, such as sender financial institution system 120 (FIG. 1), to the receiver account, such as receiver account 141 (FIG. 1), maintained by the receiver financial institution, such as receiver financial institution system 140 (FIG. 1). In some embodiments, facilitating the first electronic fund transfer of block 240 can include providing a risk score to the sender financial institution and/or the receiver financial institution to decide whether to transfer/receive the donation amount. A risk score provided to the sender financial institution and a risk score provided to the receiver financial institution by block 240 can be identical to or different from each other.

Still referring to FIG. 2, in some embodiments, method 200 further can include block 250 of the system, such as system 100 or 110 (FIG. 1), facilitating, through the computer network, such as network 160 (FIG. 1), a second electronic fund transfer of the matching donation amount from the matching sender account, such as matching sender account 131 (FIG. 1), maintained by the matching sender financial institution, such as matching sender financial institution system 130 (FIG. 1), to the receiver account, such as receiver account 141 (FIG. 1), maintained by the receiver financial institution, such as receiver financial institution system 140 (FIG. 1). In some embodiments, facilitating the first electronic fund transfer of block 250 can include providing a risk score to the matching sender financial institution and/or the receiver financial institution to decide whether to transfer/receive the matching donation amount. A risk score provided to the matching sender financial institution and a risk score provided to the receiver financial institution by block 250 can be identical to or different from each other. The respective risk scores provided to the receiver financial institution by block 240 and block 250 can be identical to or different from each other. In a number of embodiments, block 240 and block 250 can be performed in the sequence shown in FIG. 2, in a reversed order, or concurrently. In some embodiments when the sender financial institution is the matching sender financial institution and the sender account is the matching sender account, block 240 and block 250 can be combined so that the first and second electronic fund transfers can be combined into a single fund transfer.

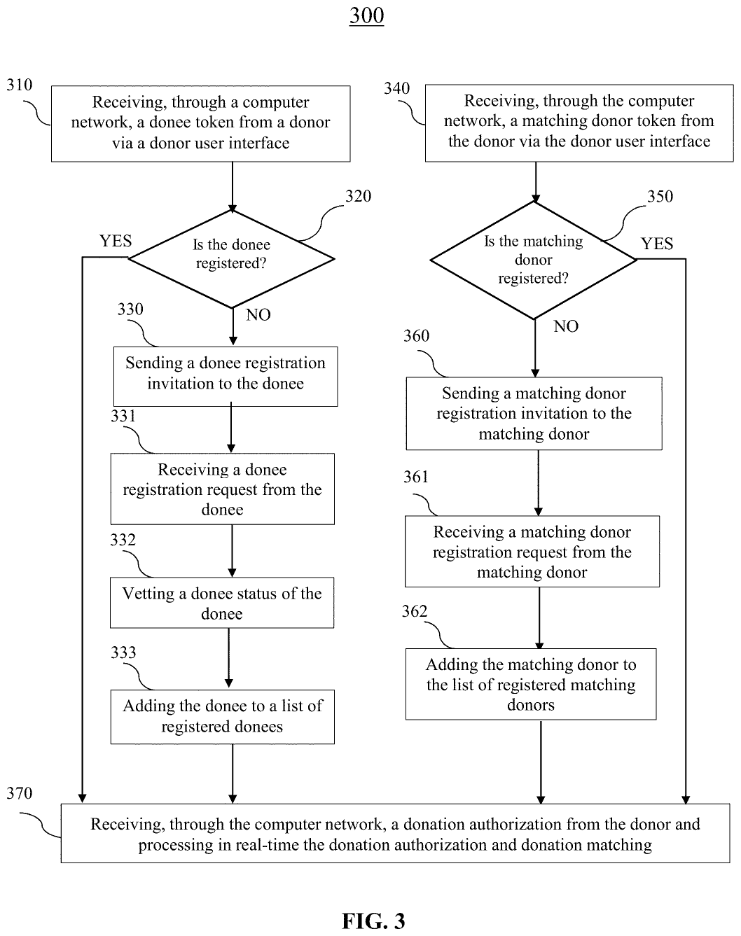

Turning ahead in the drawings, FIG. 3 illustrates a flow chart for a method 300, according to an embodiment. In some embodiments, method 300 can be a method of a system allowing a donee and/or a matching donor to register for the system to process a donation authorization and corresponding donation matching. Method 300 is merely exemplary and is not limited to the embodiments presented herein. Method 300 can be employed in many different embodiments or examples not specifically depicted or described herein. In some embodiments, the procedures, the processes, and/or the activities of method 300 can be performed in the order presented. In other embodiments, the procedures, the processes, and/or the activities of method 300 can be performed in any suitable order. In still other embodiments, one or more of the procedures, the processes, and/or the activities of method 300 can be combined or skipped. In a number embodiments, the procedures, the processes, and/or the activities of method 300 each can be identical or similar to one or more of the processes, and/or the activities of method 200. In some embodiments, method 300 can be performed by system 100 and/or system 110 (FIG. 1).

Referring to FIG. 3, in some embodiments, method 300 can include one or more blocks. Specifically, in a number of embodiments, method 300 can include a block 310 of the system, such as system 100 and/or system 110 (FIG. 1), receiving, through a computer network, such as network 160 (FIG. 1), a donee token for a donee, such as donee 153 (FIG. 1), from a donor, such as donor 151 (FIG. 1), via a donor user interface executed on a donor device, such as donor device 152 (FIG. 1). In a number of embodiments, the donor user interface can be configured for the donor to provide information pertaining to a donation authorization and/or donation matching, including identifying information of the donee and/or the matching donor, such as the donee token and/or the matching donor token. The donor user interface can be a graphical user interface of a software program executed on the donor device or a webpage obtained, through the computer network, such as network 160 (FIG. 1), from a web server, such as system 100 (FIG. 1), system 110 (FIG. 1), sender financial institution system 120 (FIG. 1), and/or matching sender financial institution system 130 (FIG. 1). The donor user interface can include one or more input controls for receiving the donee token from the donor, such as: (a) a first input control for the donor to enter or submit the donee token, (b) a second input control for the donor to submit a search inquiry to a search server and select the donee token based on the search result from the search server, or (c) a third input control for the donor to select among a list of registered donees provided by the donor device (e.g., one or more previously selected donees) or the search server (e.g., a list of all of the registered donees). In some embodiments, the search server can include, or be included in, one or more of the system, such as system 100 and/or system 110 (FIG. 1), a sender financial institution, such as sender financial institution system 120 (FIG. 1) or matching sender financial institution system 130 (FIG. 1), or any other server.

In a number of embodiments, method 300 also can include a block 320 of the system, such as system 100 and/or system 110 (FIG. 1), determining whether the donee token is associated with a registered donee. The determination of block 320 can be made by the system based on information obtained by one or more of: (a) accessing one or more non-transitory computer-readable media of the system; (b) accessing a database, e.g., database 111 (FIG. 1), communicably coupled to the system; or (c) requesting, in real-time through the computer network, this information from a server, e.g., sender financial institution system 120 (FIG. 1), matching sender financial institution system 130 (FIG. 1), or receiver financial institution system 140 (FIG. 1). In some embodiments, when the donee token is not associated with any registered donee, method 300 can include one or more blocks, such as blocks 330, 331, 332, and 333, to allow the unregistered donee associated with the donee token to register.

In certain embodiments, method 300 further can include a block 330 of the system, such as system 100 and/or system 110 (FIG. 1), sending a donee registration invitation, through the computer network, such as network 160 (FIG. 1), to the donee. The donee registration invitation can be sent to the donee directly or indirectly, such as through the donor. The donee registration invitation can include an application form and/or a hyperlink to an online application form for the donee to fill out. The donee registration invitation can be sent via any suitable electronic communication channels, such as emails, text messages, instant messages, and so forth.

In a number of embodiments, method 300 also can include a block 331 of the system, such as system 100 and/or system 110 (FIG. 1), receiving a donee registration request, through the computer network, such as network 160 (FIG. 1), from the donee, such as donee 153 (FIG. 1), via a donee user interface executed on a donee device, such as donee device 154 (FIG. 1). The donee registration request can include, or correspond to, the aforementioned application form or the online application form filled out by the donee. The donee registration request further can include information of the donee, such as a name, an entity type, the EIN, a mailing address, a phone number, one or more alternate donee tokens, a tax-exempt status, the receiver account, the receiver financial institution, and so forth.

In a few embodiments, method 300 further can include a block 332 of the system, such as system 100 and/or system 110 (FIG. 1), after receiving the donee registration request, vetting a donee status of the donee. Vetting the donee status of block 332 can be performed by one or more of: (a) retrieving, in real-time and through the computer network, such as network 160 (FIG. 1), from the receiver financial institution a good-standing status associated with the receiver bank account; (b) retrieving, in real-time and through the computer network, from a charity vetting server a charity status associated with the donee; or (c) retrieving, in real-time and through the computer network, from one or more public sources, such as a database of a tax authority, a government agency, or a reputable organization, etc.

In a number of embodiments, method 300 also can include a block 333 of the system, such as system 100 and/or system 110 (FIG. 1), after successfully vetting the donee status of the donee, adding the donee to a list of registered donees. Adding the donee to the list of registered donees of block 333 further can include updating the records in the device, server, and/or database where the data of the registered donees are maintained, such as the system, system 100 or 110 (FIG. 1), database 111 (FIG. 1), or receiver financial institution system 140 (FIG. 1), etc.

Still referring to FIG. 3, in some embodiments, method 300 further can include block 340 of the system, such as system 100 or 110 (FIG. 1), receiving, through the computer network, such as network 160 (FIG. 1), a matching donor token for a matching donor, such as matching donor 155 (FIG. 1), from the donor, such as donor 151 (FIG. 1), via the donor user interface executed on the donor device, such as donor device 152 (FIG. 1). In a few embodiments, the donor user interface can be configured to receive the matching donor token directly from the donor and transmit the matching donor token to the system, through the computer network. In certain embodiments, the donor user interface can be configured to receive an indication from the donor regarding donation matching and obtain a potential matching donor token stored in a profile of the donor, if the profile includes a donation matching history or a token for an employer of the donor. The donor user interface also can be configured to ask the donor to confirm that the potential matching donor token is the matching donor token before submitting the matching donor token to the system.

In some embodiments, method 300 further can include a block 350 of the system, such as system 100 and/or system 110 (FIG. 1), making, in real-time, a determination of whether the matching donor token is associated with a registered matching donor. The system can make the determination of block 350 based on information obtained by one or more of: (a) accessing one or more non-transitory computer-readable media of the system; (b) accessing a database, such as database 111 (FIG. 1), communicably coupled to the system; or (c) requesting, in real-time through the computer network, the information from a server, such as sender financial institution system 120 (FIG. 1), matching sender financial institution system 130 (FIG. 1), or receiver financial institution system 140 (FIG. 1). In some embodiments, when the determination of block 350 indicates that the matching donor token is not associated with any registered matching donor, method 300 also can include one or more blocks, such as blocks 360, 361, and 362, to allow the unregistered matching donor associated with the matching donor token to register.

In certain embodiments, method 300 further can include a block 360 of the system, such as system 100 and/or system 110 (FIG. 1), sending a matching donor registration invitation, through the computer network, such as network 160 (FIG. 1), to the matching donor. The matching donor registration invitation can be sent to the matching donor directly or indirectly, such as through the donor. The matching donor registration invitation can include an application form and/or a hyperlink to an online application form for the matching donor to fill out.

In a number of embodiments, method 300 also can include a block 361 of the system, such as system 100 and/or system 110 (FIG. 1), receiving a matching donor registration request, through the computer network, such as network 160 (FIG. 1), from the matching donor, such as matching donor 155 (FIG. 1), via a matching donor user interface executed on a matching donor device, such as matching donor device 156 (FIG. 1). The matching donor registration request can include, or correspond to, the application form or the online application form provided by block 360 and filled out by the matching donor. The matching donor registration request further can include information of the matching donor, such as a name, an entity type, the EIN, a mailing address, a phone number, an email address, one or more alternate matching donor tokens, the matching donor account, the matching donor financial institution, the matching policy, and so forth.

In some embodiments, method 300 further can include a block 362 of the system, such as system 100 and/or system 110 (FIG. 1), after receiving the matching donor registration request, adding the matching donor to a list of registered matching donors. Adding the matching donor to the list of registered matching donors of block 362 can include inserting a new record to the device, server, or database configured to maintain the list of registered matching donors, such as the system, system 100 or 110 (FIG. 1), database 111 (FIG. 1), matching sender financial institution system 130 (FIG. 1), etc.

In some embodiments, method 300 also can include another block (not shown in FIG. 3) of the system, such as system 100 and/or system 110 (FIG. 1), after receiving the matching donor registration request, vetting a matching donor status of the matching donor. In different or similar embodiments, vetting the matching donor status can be included in block 361 or block 362. Vetting the matching donor status can be performed by one or more of: (a) retrieving, in real-time and through the computer network, such as network 160 (FIG. 1), from the receiver financial institution a good-standing status associated with the matching donor bank account; (b) retrieving, in real-time and through the computer network, from an employer vetting server or other server a business status or other status associated with the matching donor; or (c) retrieving, in real-time and through the computer network, from one or more public sources or other sources, such as a database of a tax authority, a government agency, or a reputable organization, etc. Vetting the matching donor status also can confirm that the matching donor is the employer of or is otherwise affiliated with the donor in order to authorize the donor to participate in the donation matching program offered by the matching donor.

Still referring to FIG. 3, in some embodiments, method 300 further can include a block 370 of the system, such as system 100 and/or system 110 (FIG. 1), receiving, through the computer network, such as network 160 (FIG. 1), a donation authorization from the donor and processing in real-time the donation authorization and donation matching, when the donee is a registered donee and when the matching donor is a registered matching donor. In some embodiments, block 370 can be identical or similar to one or more of blocks 210, 220, 230, 240, and/or 250 (FIG. 2).

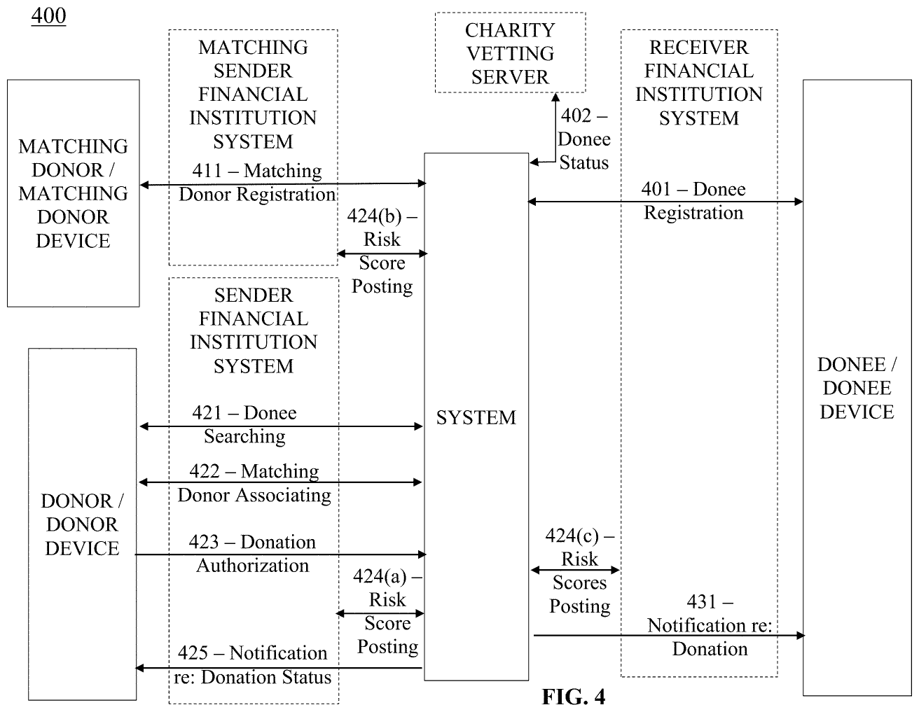

Turning ahead in the drawings, FIG. 4 illustrates a flow chart for a method 400, according to an embodiment. In some embodiments, method 400 can be a method of processing in real-time donation authorizations and donation matchings. Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped. In some embodiments, method 400 can be performed by system 100 and/or system 110 (FIG. 1). In a few embodiments, one or more procedures, processes, and/or activities of method 400 can be similar or identical to one or more procedures, processes, and/or activities of method 200 (FIG. 2) and/or one or more procedures, processes, and/or activities of method 300 (FIG. 3).

Referring to FIG. 4, in some embodiments, method 400 can include one or more steps. Specifically, in a number of embodiments, method 400 can include a step 401 of a system, such as SYSTEM, processing an application for donee registration, through the computer network, by a donee via a donee user interface executed on a donee device of the donee, such as DONEE DEVICE. In some embodiments, step 401 can include one or more of blocks 310, 330, 331, 332, and/or 333 (FIG. 3). SYSTEM can be similar or identical to system 100 and/or system 110 (FIG. 1). SYSTEM can be configured to be communicably coupled to a database, such as database 111 (FIG. 1), for storing data for registered donees. The computer network can be similar or identical to network 160 (FIG. 1). DONEE DEVICE can be similar or identical to donee device 154 (FIG. 1). Examples of the donee user interface can include a graphical user interface of an applet or software program installed on the donee device or a webpage provided by the system or a receiver financial institution system, such as RECEIVER FINANCIAL INSTITUTION SYSTEM or receiver financial institution system 140 (FIG. 1).

In a number of embodiments, the application for donee registration can include donee information associated with the donee, such as at least one donee token uniquely associated with the donee. The at least one donee token can include contact information, such as an email address, a barcode, and/or a phone number of the donee. The donee token further can be uniquely associated with a receiver account for the donee, such as receiver account 141 (FIG. 1), and the receiver account can be maintained by a receiver financial institution, such as RECEIVER FINANCIAL INSTITUTION SYSTEM or receiver financial institution system 140 (FIG. 1). In certain embodiments where the donee information also includes a donee status, such as a tax-exempt status, a good-standing status, etc., step 401 can further include vetting the donee status. Vetting the donee status of step 401 can be similar or identical to block 332 (FIG. 3). In some embodiments, when step 401 fails to vet or confirm the donee status, the process of donee registration is terminated, and the donee is not registered.

In some embodiments, method 400 further can include a step 402 of the system vetting, in real-time and via the computer network, a donee status of a donee with a charity vetting server, such as CHARITY VETTING SERVER. In certain embodiments, step 402 can be performed during the process of donee registration, e.g., step 401; when a donor or a system inquires about the donee status; before a donation to the donee is processed; before a donation matching to the donee is processed; and/or periodically, e.g., monthly, quarterly, or annually, etc. CHARITY VETTING SERVER can be SYSTEM, a tax authority system, a government agency system, and/or a third-party system for maintaining data concerning charities, including a tax-exempt status, a good-standing status, credit reports, credible negative news about a charity, and so forth. In some embodiments, vetting the donee status of step 402 can include the system receiving a score regarding the donee from CHARITY VETTING SERVER and determining the donee status based on the score and a predetermined threshold. In other or similar embodiments, vetting the donee status of step 402 also can include the system receiving data associated with the donee from CHARITY VETTING SERVER and determining the donee status based on various factors of the data. In a few embodiments, vetting the donee status of step 402 can include the system receiving the result from CHARITY VETTING SERVER.

Still referring to FIG. 4, in a number of embodiments, method 400 also can include a step 411 of the system accepting an application for matching donor registration, through the computer network, by a matching donor via a matching donor user interface executed on a matching donor device of the matching donor, such as MATCHING DONOR DEVICE. The system can be configured to be communicably coupled to a database, such as database 111 (FIG. 1), for storing data for registered matching donors. The database for the data for registered matching donors can be the database for registered donees. MATCHING DONOR DEVICE can be similar or identical to matching donee device 156 (FIG. 1). In some embodiments, step 411 can include one or more of blocks 340, 360, 361, and/or 362 (FIG. 3). Examples of the matching donor user interface of step 411 can include a graphical user interface of an applet or software program installed on the matching donor device or a webpage provided by the system, such as SYSTEM, system 100 or 110 (FIG. 1), or a matching sender financial institution system, such as MATCHING SENDER FINANCIAL INSTITUTION SYSTEM or matching sender financial institution system 130 (FIG. 1). Step 411 can further include vetting the matching donor status. Vetting the matching donor status of step 411 can be similar or identical the process of vetting the machine donor status, as described above with reference to FIG. 3. In some embodiments, when step 411 fails to vet or confirm the matching donor status, the process of matching donor registration is terminated, and the matching donor is not registered.

In some embodiments, method 400 further can include step 421 of the system performing a donee searching for one or more registered donees. In certain embodiments, step 421 can comprise: receiving by the system, such as SYSTEM, system 100 or 110 (FIG. 1), through the computer network, such as network 160 (FIG. 1), a search inquiry from a donor, such as donor 151 (FIG. 1), via the donor user interface executed on the donor device, such as DONOR DEVICE or donor device 152 (FIG. 1); and/or transmitting by the system, through the computer network, a search result to be displayed on the donor user interface for the donor. The search inquiry can comprise a donee token uniquely associated with a donee, and/or other keywords or attributes for the one or more registered donees. The search result can be determined based on the search inquiry and/or retrieved from a profile of the donor, such as one or more registered donees the donor donated to or saved as the favorites. In some embodiments when the search result is empty, step 421 further can include initiating donee registration by step 401 and/or one or more procedures, processes, and/or activities similar or identical to one or more of blocks 330, 331, 332, and/or 333 (FIG. 3).

In certain embodiments, step 421 further can include after determining the search result, vetting, by the system, a donee status for each of one or more registered donees in the search result, such as step 402, and deleting any donee that fails the status vetting from the search result before transmitting the search result to the donor. The profile of the donor can be stored in one or more of the donor device, the system, the database, the sender financial institution system, such as SENDER FINANCIAL INSTITUTION SYSTEM or sender financial institution system 120 (FIG. 1), or any suitable database or server, such as database 111 (FIG. 1). Examples of the donor user interface can include a graphical user interface of an applet or software program installed on the donor device or a webpage provided by the system or a sender financial institution system, such as SENDER FINANCIAL INSTITUTION SYSTEM or sender financial institution system 120 (FIG. 1).

In a number of embodiments, method 400 also can include step 422 of the system associating the donor with a matching donor for donation matching. The matching donor can be identified by the donor, via the donor user interface through the computer network, or obtained from the profile of the donor, stored in the donor device, the sender financial institution system, the system, and/or any suitable device, database, or server, such as database 111 (FIG. 1). In certain embodiments, step 422 can include associating the donor with the employer of the donor, as the matching donor, based on the profile of the donor. In some embodiments, step 422 further can include confirming that the matching donor is registered before the system determines whether the donor is associated with the matching donor for donation matching. In similar or different embodiments, step 422 further can include initiating matching donor registration by step 411 and/or one or more procedures, processes, and/or activities similar or identical to blocks 340, 350, 360, 361, and/or 362. Furthermore, in similar or different embodiments, step 422 also can include vetting or confirming that the matching donor is the employer of or is otherwise affiliated with the donor to authorize the donor to participate in the donation matching program offered by the matching donor.

Still referring to FIG. 4, in a number of embodiments, method 400 also can include a step 423 of the system processing a donation authorization by the system receiving, through the computer network, the donation authorization from the donor via the donor user interface. The donation authorization can comprise a donation amount and a donor token for the donor. The donor token can be uniquely associated with a sender account, such as sender account 121 (FIG. 1), associated with the donor and maintained by the sender financial institution, such as SENDER FINANCIAL INSTITUTION SYSTEM and/or sender financial institution system 120 (FIG. 1).

In some embodiments, the donation amount can correspond to a donee token for a donee, such as donee 153 (FIG. 1). The donee token can be uniquely associated with a receiver account, such as receiver account 141 (FIG. 1), for the donee and maintained by a receiver financial institution, such as RECEIVER FINANCIAL INSTITUTION SYSTEM and/or receiver financial institution system 140 (FIG. 1). In some embodiments, the donee token can be determined by the system or provided, through the computer network, to the system by the donor via the donor user interface in step 421 or 423. The donation amount also can correspond to a matching donor token for a matching donor. The matching donor token can be uniquely associated with a matching sender account, such as matching donor account 131 (FIG. 1), for the matching donor and maintained by a matching sender financial institution, such as MATCHING SENDER FINANCIAL INSTITUTION SYSTEM and/or matching sender financial institution system 130 (FIG. 1). In some embodiments, the matching donor token can be determined by the system or provided, through the computer network, to the system by the donor via the matching donor user interface in step 422 or 423. In certain embodiments, receiving the donation authorization of step 423 can be similar or identical to block 210 (FIG. 2) and/or block 370 (FIG. 3).

In a number of embodiments, step 423 further can include, after receiving the donation authorization, determining by the system, in real-time, whether the donation authorization complies with a matching policy of the matching donor. The matching policy can be predetermined by and received, through the computer network, from the matching donor via a matching donor user interface executed on a matching donor device, such as MATCHING DONOR DEVICE or matching donor device 155 (FIG. 1). In some embodiments, the matching policy can be predetermined while the matching donor applies, via the matching donor user interface, to register with the system in step 411 or any time after the matching donor is registered. In several embodiments, determining whether the donation authorization complies with the matching policy of step 423 can be similar or identical to block 220 (FIG. 2).

In a number of embodiments, step 423 also can include, after determining that the donation authorization complies with the matching policy, determining by the system, in real-time, a matching donation amount based at least in part on the matching policy. The matching policy also can include one or more rules and/or formulas about how the matching donation amount is calculated. In several embodiments, determining the matching donation amount of step 423 can be similar or identical to block 230 (FIG. 2).

Still referring to FIG. 4, in some embodiments, method 400 further can include one or more steps 424, such as 424(a), 424(b), and/or 424(c), of the system facilitating one or more electronic fund transfers, after receiving the donation authorization. In certain embodiments, the one or more steps 424 can comprise facilitating, through the computer network, a first electronic fund transfer of the donation amount from the sender account, such as sender account 121 (FIG. 1), maintained by the sender financial institution, such as SENDER FINANCIAL INSTITUTION SYSTEM or sender financial institution system 120 (FIG. 1), to the receiver account, such as receiver account 141 (FIG. 1), maintained by the receiver financial institution, such as RECEIVER FINANCIAL INSTITUTION SYSTEM or receiver financial institution system 140 (FIG. 1). Facilitating the first electronic fund transfer of the one or more steps 424 can be similar or identical block 240 (FIG. 2).

In some embodiments, facilitating the first electronic fund transfer of the one or more steps 424 can include step 424 (a) of the system providing a first risk score to the sender financial institution for the sender financial institution to determine whether a first risk associated with the first electronic fund transfer is acceptable. In similar or different embodiments, facilitating the first electronic fund transfer of the one or more steps 424 further can include step 424 (c) of the system providing a second risk score to the receiver financial institution for the receiver financial institution to determine whether a second risk of the first electronic fund transfer is acceptable. The first risk score and the second risk score each can correspond to a respective likelihood of fraud and/or one or more financial crimes associated with the first electronic fund transfer. The first risk and the second risk can be similar or identical to each other. The first risk score and the second risk score can be the same. In several embodiments, if the first risk is acceptable to the sender financial institution and the second risk is acceptable to the receiver financial institution, then the one or more steps 424 further can include initiating, by the sender financial institution or the receiver financial institution, a settlement of first electronic fund transfer, via any suitable channel, such as Automated Clearing House (ACH) or any electronic payment network, in real-time, in a batch, or at a time determined based on the donation authorization.

Furthermore, in some embodiments, the one or more steps 424 also can comprise the system facilitating, through the computer network, a second electronic fund transfer of the donation amount from the matching sender account, such as matching sender account 131 (FIG. 1), maintained by the matching sender financial institution, such as MATCHING SENDER FINANCIAL INSTITUTION SYSTEM or matching sender financial institution system 130 (FIG. 1), to the receiver account, such as receiver account 141 (FIG. 1), maintained by the receiver financial institution, such as RECEIVER FINANCIAL INSTITUTION SYSTEM or receiver financial institution system 140 (FIG. 1). Facilitating the second electronic fund transfer of the one or more steps 424 can be similar or identical to block 250 (FIG. 2).

In a few embodiments, facilitating the second electronic fund transfer of the one or more steps 424 can include step 424 (b) of the system providing a third risk score to the matching sender financial institution for the matching sender financial institution to determine whether a third risk associated with the second electronic fund transfer is acceptable. In similar or different embodiments, facilitating the second electronic fund transfer of the one or more steps 424 further can include step 424 (c) of the system providing a fourth risk score to the receiver financial institution for the receiver financial institution to determine whether a fourth risk of the first electronic fund transfer is acceptable. The third risk score and the fourth risk score each can correspond to a respective likelihood of fraud and/or one or more financial crimes associated with the second electronic fund transfer. The third risk and the fourth risk can be similar or identical to each other. The third risk score and the fourth risk score can be the same. In a few embodiments, when the third risk is acceptable to the matching sender financial institution and the fourth risk is acceptable to the receiver financial institution, then the one or more steps 424 further can include initiating, by the matching sender financial institution or the receiver financial institution, a settlement of second electronic fund transfer, via any suitable channel, such as ACH or any electronic payment network, in real-time, in a batch, or at a time determined based on the donation authorization.

Still referring to FIG. 4, in a number of embodiments, method 400 also can include a step 425 of the system sending, via the computer network, a notification to the donor about a status of the donation and/or the donation matching after the one or more steps 424. In some embodiments, method 400 further can include a step 431 of the system sending, via the computer network, a notification to the donee about the status of the donation and/or donation matching after the one or more steps 424. In certain embodiments, the notification to the donor of step 425 also can include delivering a receipt for the donation amount. Additionally, in some embodiments, method 400 further can include one or more additional or alternative steps, processes, procedures, and/or acts, such as: sending, via the computer network, a notification about a status of the donation matching and/or a delivery of a receipt of the matching donation amount to the matching donor after the one or more steps 424; determining, by the system in the one or more steps 424, whether the first electronic fund transfer and the second electronic fund transfer can be combined into a single electronic fund transfer before facilitating the first and second electronic fund transfers; and so forth.

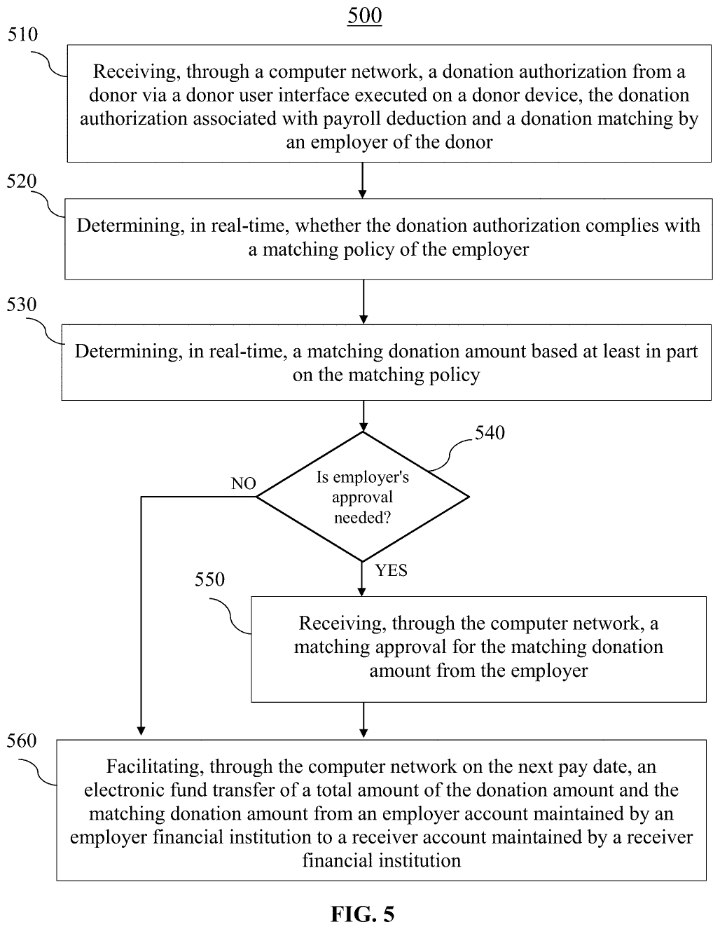

Turning ahead in the drawings, FIG. 5 illustrates a flow chart for a method 500, according to an embodiment. In some embodiments, method 500 can be a method of a system processing a donation authorization associated with payroll deduction and donation matching by an employer. Method 500 is merely exemplary and is not limited to the embodiments presented herein. Method 500 can be employed in many different embodiments or examples not specifically depicted or described herein. In some embodiments, the procedures, the processes, and/or the activities of method 500 can be performed in the order presented. In other embodiments, the procedures, the processes, and/or the activities of method 500 can be performed in any suitable order. In still other embodiments, one or more of the procedures, the processes, and/or the activities of method 500 can be combined or skipped. In some embodiments, method 500 can be performed by system 100 or system 110 (FIG. 1) or SYSTEM (FIG. 4). The procedures, the processes, and/or the activities of method 500 can be similar or identical to any blocks of method 200 (FIG. 2) and/or method 300 (FIG. 3), and/or any steps of method 400 (FIG. 4).

Referring to FIG. 5, in a number embodiment, method 500 can include one or more blocks. Specifically, in some embodiments, method 500 can include a block 510 of a system receiving, through a computer network, a donation authorization from a donor via a donor user interface executed on a donor device, the donation authorization associated with payroll deduction and a donation matching by an employer of the donor. In some embodiments, the donation authorization can comprise a donation amount and a donor token for the donor. The donor token can be uniquely associated with an employer account of the employer for issuing paychecks to the donor and for payroll deduction. In some embodiments, the donation amount can correspond to a donee token for a donee, such as donee 153 (FIG. 1). The donee token can be uniquely associated with a receiver account, such as receiver account 141 (FIG. 1), for the donee and maintained by a receiver financial institution, such as RECEIVER FINANCIAL INSTITUTION SYSTEM (FIG. 4) and/or receiver financial institution system 140 (FIG. 1).

In some embodiments, the system can be similar or identical to system 100 or system 110 (FIG. 1), or SYSTEM (FIG. 4). The computer network can be similar or identical to network 160 (FIG. 1). The donor can be donor 151 (FIG. 1). The donor device can be donor device 152 (FIG. 1) or DONOR DEVICE (FIG. 4). The employer can be matching donor 155 (FIG. 1). The donor can be associated with an employer account for the employer, and the employer account can be maintained by an employer financial institution. In some embodiments, the employer financial institution can be sender financial institution system 120 (FIG. 1), matching sender financial institution system 130 (FIG. 1), SENDER FINANCIAL INSTITUTION SYSTEM (FIG. 4), or MATCHING SENDER FINANCIAL INSTITUTION SYSTEM (FIG. 4). The employer account can be sender account 121 (FIG. 1) or matching sender account 131 (FIG. 1). In some embodiments, block 510 can be similar or identical to block 210 (FIG. 2), block 370 (FIG. 3), and/or step 423 (FIG. 4). In a few embodiments, method 500 further can include, before receiving the donation authorization, one or more blocks (not shown in FIG. 5) that are similar or identical to one or more of block 310, block 320, block 330, block 331, block 332, block 333, block 340, block 350, block 360, block 361, block 362 (FIG. 3), step 421, or step 422 (FIG. 4).

In a number of embodiments, method 500 also can include a block 520 of the system determining, in real-time, whether the donation authorization complies with a matching policy of the employer, after receiving the donation authorization. The matching policy can include one or more rules about eligibility of the donor or the donee; a first prospective accumulated amount by the employer; a second prospective accumulated amount, associated with one or more employees or the donee, by the employer, etc. The matching policy can be predetermined by the employer, via a matching donor user interface executed on a matching donor device, such as matching donor device 156 (FIG. 1). In a few embodiments, block 520 can be similar or identical to block 220 (FIG. 2).

In several embodiments, method 500 further can include a block 530 of the system determining, in real-time, a matching donation amount based at least in part on the matching policy. In some embodiments, the matching policy of the employer also can include one or more rules or equations about how to calculate the matching donation amount. The matching donation amount can be less than, equal to, or greater than the donation amount. The matching donation amount further can be determined based, at least in part, on other factors, such as the donation amount. In a number of embodiments, block 530 can be similar or identical to block 230 (FIG. 2).

In some embodiments, method 500 also can include a block 540 of the system determining whether an approval for the donation matching amount by the employer is needed, based at least in part on the matching policy of the employer. When it is determined in block 540 that the approval by the employer is required, in certain embodiments, method 500 further can include a block 550 of the system, receiving, through the computer network, a matching approval for the matching donation amount from the employer, via the matching donor user interface. In several embodiments, method 500 also can include, after determining that the approval for the donation matching account by the employer is needed, before receiving the matching approval, the system sending, in real-time through the computer network, a request for matching approval to be displayed on the matching donor user interface for the employer.

In some embodiments, method 500 also can include a block 560 of the system facilitating, through the computer network on the next pay date, an electronic fund transfer of the total or combined amount of the donation amount and the matching donation amount from the employer account maintained by the employer financial institution to the receiver account maintained by the receiver financial institution. In some embodiments, facilitating the electronic fund transfer of bock 560 can include providing, by the system in real-time: (a) a first risk score to the employer financial institution so that the employer financial institution can determine whether a first risk associated with the electronic fund transfer is acceptable; and/or (b) a second risk score to a receiver financial institution so that the receiver financial institution can determine whether a second risk corresponding to the electronic fund transfer is acceptable. The first risk score and the second risk score each can correspond to a respective likelihood of fraud and/or one or more financial crimes associated with the electronic fund transfer. The first risk and the second risk can be similar or identical to each other. The first risk score and the second risk score can be the same. In a number of embodiments, block 560 can be similar or identical to block 240 and/or block 250 (FIG. 2), block 370 (FIG. 3), and/or the one or more steps 424 (FIG. 4).

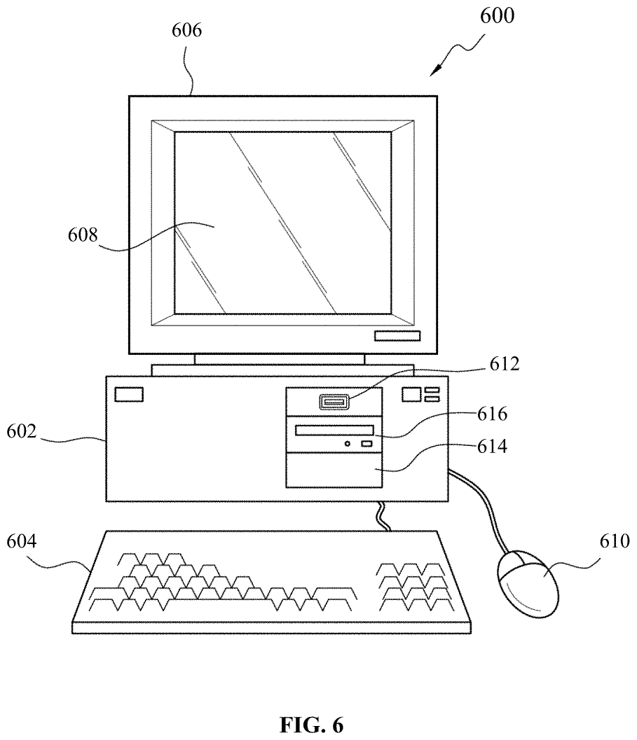

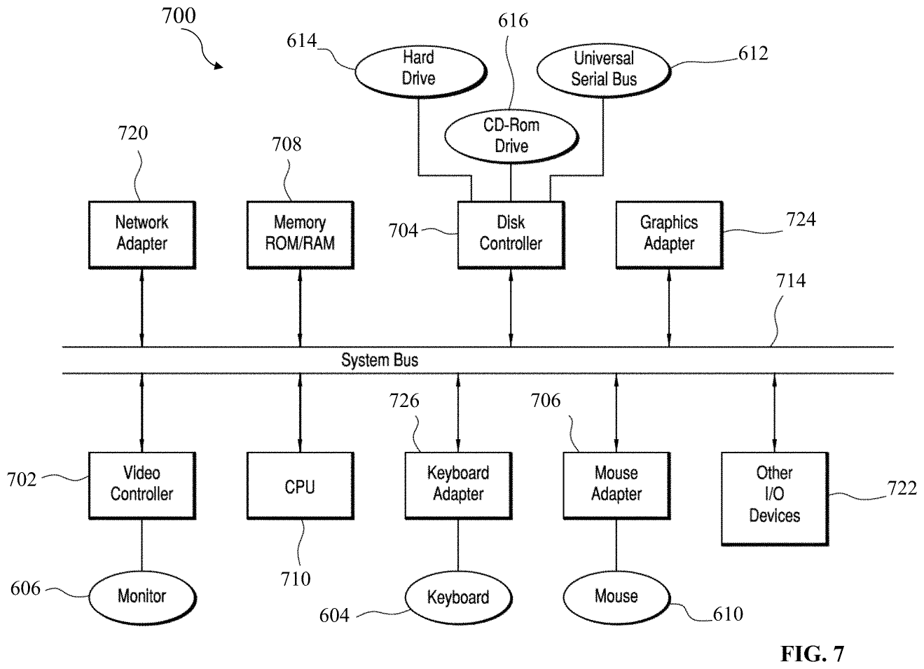

Turning ahead in the drawings, FIG. 6 illustrates a computer 600, all of which or a portion of which can be suitable for implementing an embodiment of at least a portion of system 100 (FIG. 1), system 110 (FIG. 1), sender financial institution system 120 (FIG. 1), matching sender financial institution system 130 (FIG. 1), receiver financial institution system 140 (FIG. 1), donor device 152 (FIG. 1), donee device 154 (FIG. 1), matching donor device 156 (FIG. 1), SYSTEM (FIG. 4), DONOR DEVICE (FIG. 4), MATCHING DONOR DEVICE (FIG. 4), DONEE DEVICE (FIG. 4), SENDER FINANCIAL INSTITUTION SYSTEM (FIG. 4), MATCHING SENDER FINANCIAL INSTITUTION SYSTEM (FIG. 4), RECEIVER FINANCIAL INSTITUTION SYSTEM (FIG. 4), CHARITY VETTING SERVER (FIG. 4), and/or the techniques/systems described in method 200 (FIG. 2), method 300 (FIG. 3), method 400 (FIG. 4), and/or method 500 (FIG. 5). Computer 600 includes a chassis 602 containing one or more circuit boards (not shown), a USB (universal serial bus) port 612, a Compact Disc Read-Only Memory (CD-ROM) and/or Digital Video Disc (DVD) drive 616, and a hard drive 614. A representative block diagram of the elements included on the circuit boards inside chassis 602 is shown in FIG. 7. A central processing unit (CPU) 710 in FIG. 7 is coupled to a system bus 714 in FIG. 7. In various embodiments, the architecture of CPU 710 can be compliant with any of a variety of commercially distributed architecture families.

Continuing with FIG. 7, system bus 714 also is coupled to memory 708 that includes both read only memory (ROM) and random access memory (RAM). Non-volatile portions of memory storage unit 708 or the ROM can be encoded with a boot code sequence suitable for restoring computer 600 (FIG. 6) to a functional state after a system reset. In addition, memory 708 can include microcode such as a Basic Input-Output System (BIOS). In some examples, the one or more memory storage units of the various embodiments disclosed herein can comprise memory storage unit 708, a USB-equipped electronic device, such as, an external memory storage unit (not shown) coupled to universal serial bus (USB) port 612 (FIGS. 6-7), hard drive 614 (FIGS. 6-7), and/or CD-ROM or DVD drive 616 (FIGS. 6-7). In the same or different examples, the one or more memory storage units of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Some examples of common operating systems can comprise Microsoft® Windows® operating system (OS), Mac® OS, UNIX® OS, and Linux® OS.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 710.

In the depicted embodiment of FIG. 7, various I/O devices such as a disk controller 704, a graphics adapter 724, a video controller 702, a keyboard adapter 726, a mouse adapter 706, a network adapter 720, and other I/O devices 722 can be coupled to system bus 714. Keyboard adapter 726 and mouse adapter 706 are coupled to a keyboard 604 (FIGS. 6 and 7) and a mouse 610 (FIGS. 6 and 7), respectively, of computer 700 (FIG. 7). While graphics adapter 724 and video controller 702 are indicated as distinct units in FIG. 7, video controller 702 can be integrated into graphics adapter 724, or vice versa in other embodiments. Video controller 702 is suitable for refreshing a monitor 606 (FIGS. 6 and 7) to display images on a screen 608 (FIG. 6) of computer 600 (FIG. 6). Disk controller 704 can control hard drive 614 (FIGS. 6 and 7), USB port 612 (FIGS. 6 and 7), and CD-ROM or DVD drive 616 (FIGS. 6 and 7). In other embodiments, distinct units can be used to control each of these devices separately.

In some embodiments, network adapter 720 can comprise and/or be implemented as a WNIC (wireless network interface controller) card (not shown) plugged or coupled to an expansion port (not shown) in computer system 600 (FIG. 6). In other embodiments, the WNIC card can be a wireless network card built into computer system 600 (FIG. 6). A wireless network adapter can be built into computer system 600 (FIG. 6) by having wireless communication capabilities integrated into the motherboard chipset (not shown), or implemented via one or more dedicated wireless communication chips (not shown), connected through a PCI (peripheral component interconnector) or a PCI express bus of computer system 600 (FIG. 6) or USB port 612 (FIG. 6). In other embodiments, network adapter 720 can comprise and/or be implemented as a wired network interface controller card (not shown).

Although many other components of computer 600 (FIG. 6) are not shown, such components and their interconnection are well known to those of ordinary skill in the art. Accordingly, further details concerning the construction and composition of computer 600 and the circuit boards inside chassis 602 (FIG. 6) need not be discussed herein.

When computer 600 in FIG. 6 is running, program instructions stored on a USB drive in USB port 612, on a CD-ROM or DVD in CD-ROM and/or DVD drive 616, on hard drive 614, or in memory 708 (FIG. 7) are executed by CPU 710 (FIG. 7). A portion of the program instructions, stored on these devices, can be suitable for carrying out all or at least part of the techniques described herein. In various embodiments, computer 700 can be reprogrammed with one or more modules, applications, and/or databases to convert a general purpose computer to a special purpose computer.

Although computer system 600 is illustrated as a desktop computer in FIG. 6, there can be examples where computer system 600 may take a different form factor while still having functional elements similar to those described for computer system 600. In some embodiments, computer system 600 may comprise a single computer, a single server, or a cluster or collection of computers or servers, or a cloud of computers or servers. Typically, a cluster or collection of servers can be used when the demand on computer system 600 exceeds the reasonable capability of a single server or computer. In certain embodiments, computer system 600 may comprise a portable computer, such as a laptop computer. In certain other embodiments, computer system 600 may comprise a mobile device, such as a smartphone. For example, donor device 152 (FIG. 1) can be a mobile device, such as a smartphone. In certain additional embodiments, computer system 600 may comprise an embedded system.

Although systems and/or methods for processing real-time donations have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-7 may be modified, and that the foregoing discussion of certain of these embodiments does not necessarily represent a complete description of all possible embodiments. For example, one or more of the procedures, processes, or activities of FIGS. 2-5 may include different procedures, processes, and/or activities and be performed by many different modules, in many different orders, and/or one or more of the procedures, processes, or activities of FIGS. 2-5 may include one or more of the procedures, processes, or activities of another different one of FIGS. 2-5.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

1. A system comprising:
one or more processors; and
one or more non-transitory computer-readable media storing computing instructions configured to run on the one or more processors and perform:
receiving, through a computer network, a donation authorization from a donor via a donor user interface executed on a donor device, wherein:
the donation authorization comprises a donation amount and a donor token for the donor;
the donor token is uniquely associated with a sender account associated with the donor and maintained by a sender financial institution;
the donation amount corresponds to a donee token for a donee, wherein the donee token is uniquely associated with a receiver account for the donee and maintained by a receiver financial institution; and
the donation amount corresponds to a matching donor token for a matching donor, wherein the matching donor token is uniquely associated with a matching sender account for the matching donor and maintained by a matching sender financial institution;
after receiving the donation authorization, determining, in real-time, whether the donation authorization complies with a matching policy of the matching donor, wherein:
the matching policy is predetermined by and received, through the computer network, from the matching donor via a matching donor user interface executed on a matching donor device;
after determining that the donation authorization complies with the matching policy, determining, in real-time, a matching donation amount based at least in part on the matching policy, wherein the matching donation amount is less than, equal to, or greater than the donation amount;
after determining the matching donation amount, facilitating, in real-time through the computer network, a first electronic fund transfer of the donation amount from the sender account maintained by the sender financial institution to the receiver account maintained by the receiver financial institution by:
determining, in real-time, a first fraud risk score associated with the first electronic fund transfer for the sender financial institution;
transmitting, in real-time through the computer network, the first fraud risk score to the sender financial institution;
determining, in real-time, a second fraud risk score associated with the first electronic fund transfer for the receiver financial institution;
transmitting, in real-time through the computer network, the second fraud risk score to the receiver financial institution;
upon receiving a first approval of the first fraud risk score from the sender financial institution and a second approval of the second fraud risk score from the receiver financial institution, causing, in real-time, the sender financial institution to process the first electronic fund transfer; and
upon receiving a first rejection of the first fraud risk score from the sender financial institution or a second rejection of the second fraud risk score from the receiver financial institution, terminating the first electronic fund transfer; and
after facilitating the first electronic fund transfer, facilitating, in real-time through the computer network, a second electronic fund transfer of the matching donation amount from the matching sender account maintained by the matching sender financial institution to the receiver account maintained by the receiver financial institution.

2. The system in claim 1, wherein determining whether the donation authorization complies with the matching policy further comprises:
determining, in real-time, whether one or more of:
an eligibility of the donor;
donee data of the donee;
a first prospective accumulated amount by the matching donor; or
a second prospective accumulated amount, associated with one or more of the donor or the donee, by the matching donor,
meet one or more donation matching criteria predetermined by the matching donor, via the matching donor user interface executed on the matching donor device.

3. The system in claim 1, wherein determining whether the donation authorization complies with the matching policy further comprises vetting, in real-time, donee information of the donee.

4. The system in claim 3, wherein vetting the donee information of the donee further comprises one or more of:
retrieving, in real-time and through the computer network, from the receiver financial institution a good-standing status associated with the receiver account; or
retrieving, in real-time and through the computer network, from a charity vetting server a charity status associated with the donee.

5. The system in claim 1, wherein the computing instructions are further configured to perform vetting a donee status of the donee upon one or more of:
receiving, through the computer network, a donee registration request from the donee via a donee user interface executed on a donee device of the donee;
before transmitting, through the computer network, a search result associated with one or more registered donees to be displayed on the donor user interface, in response to a donee search inquiry by the donor via the donor user interface, the one or more registered donees comprising the donee;
before facilitating the first electronic fund transfer;
before facilitating the second electronic fund transfer; or
when a predetermined time has passed after a prior vetting was performed.

6. The system in claim 1, wherein the computing instructions are further configured to perform, before receiving the donation authorization from the donor:
receiving, through the computer network, the donee token from the donor via the donor user interface;
after receiving the donee token, making, in real-time, a determination of whether the donee is registered; and
when the determination indicates that the donee is not registered, sending, in real-time through the computer network, a donee registration invitation to the donee.

7. The system in claim 1, wherein the computing instructions are further configured to perform, before receiving the donation authorization from the donor:
receiving, through the computer network, the matching donor token from the donor via the donor user interface;
after receiving the matching donor token, making, in real-time, a determination of whether the matching donor is registered; and
when the determination indicates that the matching donor is not registered, sending, in real-time through the computer network, a matching donor registration invitation to the matching donor.

8. The system in claim 1, wherein facilitating the first electronic fund transfer of the donation amount further comprises:
facilitating, through the computer network, the sender financial institution to withhold the donation amount from the sender account; and
after facilitating the sender financial institution to withhold the donation amount from the sender account, facilitating, in real-time through the computer network, the receiver financial institution to post in real-time the donation amount to the receiver account.

9. The system in claim 1, wherein facilitating the second electronic fund transfer of the matching donation amount further comprises:
facilitating, through the computer network, the matching sender financial institution to withhold the matching donation amount from the matching sender account; and
after facilitating the matching sender financial institution to withhold the matching donation amount from the matching sender account, facilitating, in real-time through the computer network, the receiver financial institution to post in real-time the matching donation amount to the receiver account.

10. The system in claim 1, wherein the computing instructions are further configured to perform:
before facilitating the first electronic fund transfer and the second electronic fund transfer, receiving, through the computer network, a matching approval for the matching donation amount from the matching donor.

11. The system in claim 1, wherein:
the sender account is one of:
a donor account uniquely associated with the donor; or
a payroll account uniquely associated with the matching donor.

12. The system in claim 1, wherein:
the matching sender account is the sender account; and
the matching sender financial institution is the sender financial institution.

13. The system in claim 12, wherein facilitating the first electronic fund transfer and the second electronic fund transfer comprises facilitating, through the computer network, a single electronic fund transaction of a total amount of the donation amount and the matching donation amount from the sender account maintained by the sender financial institution to the receiver account maintained by the receiver financial institution.

14. A method being implemented via execution of computing instructions configured to run at one or more processors and stored at one or more non-transitory computer-readable media, the method comprising:
receiving, through a computer network, a donation authorization from a donor via a donor user interface executed on a donor device, wherein:
the donation authorization comprises a donation amount and a donor token for the donor;
the donor token is uniquely associated with a sender account associated with the donor and maintained by a sender financial institution;
the donation amount corresponds to a donee token for a donee, wherein the donee token is uniquely associated with a receiver account for the donee and maintained by a receiver financial institution; and
the donation amount corresponds to a matching donor token for a matching donor, wherein the matching donor token is uniquely associated with a matching sender account for the matching donor and maintained by a matching sender financial institution;
after receiving the donation authorization, determining, in real-time, whether the donation authorization complies with a matching policy of the matching donor, wherein:
the matching policy is predetermined by and received, through the computer network, from the matching donor via a matching donor user interface executed on a matching donor device;
after determining that the donation authorization complies with the matching policy, determining, in real-time, a matching donation amount based at least in part on the matching policy, wherein the matching donation amount is less than, equal to, or greater than the donation amount;
after determining the matching donation amount, facilitating, in real-time through the computer network, a first electronic fund transfer of the donation amount from the sender account maintained by the sender financial institution to the receiver account maintained by the receiver financial institution by:
determining, in real-time, a first fraud risk score associated with the first electronic fund transfer for the sender financial institution;
transmitting, in real-time through the computer network, the first fraud risk score to the sender financial institution;
determining, in real-time, a second fraud risk score associated with the first electronic fund transfer for the receiver financial institution;
transmitting, in real-time through the computer network, the second fraud risk score to the receiver financial institution;
upon receiving a first approval of the first fraud risk score from the sender financial institution and a second approval of the second fraud risk score from the receiver financial institution, causing, in real-time, the sender financial institution to process the first electronic fund transfer; and
upon receiving a first rejection of the first fraud risk score from the sender financial institution or a second rejection of the second fraud risk score from the receiver financial institution, terminating the first electronic fund transfer; and
after facilitating the first electronic fund transfer, facilitating, in real-time through the computer network, a second electronic fund transfer of the matching donation amount from the matching sender account maintained by the matching sender financial institution to the receiver account maintained by the receiver financial institution.

15. The method in claim 14, wherein determining whether the donation authorization complies with the matching policy further comprises:
determining, in real-time, whether one or more of:
an eligibility of the donor;
donee data of the donee;
a first prospective accumulated amount by the matching donor; or
a second prospective accumulated amount, associated with one or more of the donor or the donee, by the matching donor,
meet one or more donation matching criteria predetermined by the matching donor, via the matching donor user interface executed on the matching donor device.

16. The method in claim 14, wherein determining whether the donation authorization complies with the matching policy further comprises vetting, in real-time, donee information of the donee.

17. The method in claim 16, wherein vetting the donee information of the donee further comprises one or more of:
retrieving, in real-time and through the computer network, from the receiver financial institution a good-standing status associated with the receiver account; or
retrieving, in real-time and through the computer network, from a charity vetting server a charity status associated with the donee.

18. The method in claim 14 further comprising vetting a donee status of the donee upon one or more of:
receiving, through the computer network, a donee registration request from the donee via a donee user interface executed on a donee device of the donee;
before transmitting, through the computer network, a search result associated with one or more registered donees to be displayed on the donor user interface, in response to a donee search inquiry by the donor via the donor user interface, the one or more registered donees comprising the donee;
before facilitating the first electronic fund transfer;
before facilitating the second electronic fund transfer; or
when a predetermined time has passed after a prior vetting was performed.

19. The method in claim 14, further comprising, before receiving the donation authorization from the donor:
receiving, through the computer network, the donee token from the donor via the donor user interface;
after receiving the donee token, making, in real-time, a determination of whether the donee is registered; and
when the determination indicates that the donee is not registered, transmitting, in real-time through the computer network, a donee registration invitation to the donee.

20. The method in claim 14, further comprising, before receiving the donation authorization from the donor:
receiving, through the computer network, the matching donor token from the donor via the donor user interface;
after receiving the matching donor token, making, in real-time, a determination of whether the matching donor is registered; and
when the determination indicates that the matching donor is not registered, transmitting, in real-time through the computer network, a matching donor registration invitation to the matching donor.

21. The method in claim 14, wherein facilitating the first electronic fund transfer of the donation amount further comprises:
facilitating, through the computer network, the sender financial institution to withhold the donation amount from the sender account; and
after facilitating the sender financial institution to withhold the donation amount from the sender account, facilitating, in real-time through the computer network, the receiver financial institution to post in real-time the donation amount to the receiver account.

22. The method in claim 14, wherein facilitating the second electronic fund transfer of the matching donation amount further comprises:
facilitating, through the computer network, the matching sender financial institution to withhold the matching donation amount from the matching sender account; and
after facilitating the matching sender financial institution to withhold the matching donation amount from the matching sender account, facilitating, in real-time through the computer network, the receiver financial institution to post in real-time the matching donation amount to the receiver account.

23. The method in claim 14, further comprising before facilitating the first electronic fund transfer and the second electronic fund transfer, receiving, through the computer network, a matching approval for the matching donation amount from the matching donor.

24. The method in claim 14, wherein:
the sender account is one of:
a donor account uniquely associated with the donor; or
a payroll account uniquely associated with the matching donor.

25. The method in claim 14, wherein:
the matching sender account is the sender account; and
the matching sender financial institution is the sender financial institution.

26. The method in claim 25, wherein facilitating the first electronic fund transfer and the second electronic fund transfer comprises facilitating, through the computer network, a single electronic fund transaction of a total amount of the donation amount and the matching donation amount from the sender account maintained by the sender financial institution to the receiver account maintained by the receiver financial institution.
